(19) United States
(12) Patent Application Publication
(10) Pub. No.: US 2002/0167147 A1
(43) Pub. Date: Nov. 14, 2002

(54) Method and apparatus for inhibiting stones and other objects from wedging under the wheels of a scooter

(76) Inventor: Garrett J. Muehlhauser, Prior Lake, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/113,792

(22) Filed: Apr. 1, 2002

Related U.S. Application Data
(60) Provisional application No. 60/280,288, filed on Mar. 30, 2001.

(51) Int. Cl. B62M 1/00

(52) U.S. Cl. 280/87.041

(57) ABSTRACT

A pathway clearing apparatus for a scooter. The apparatus includes a ground engaging brush and a bracket to pivotally mount the brush in front of the wheel of the scooter.

### RELATED APPLICATION

The present application claims the benefit of U.S. Provisional Application No. 60/280,288 filed Mar. 30, 2001, which is incorporated herein in its entirety by reference.

### TECHNICAL FIELD

The present invention relates to recreational scooters. More particularly, it relates to an apparatus and method for inhibiting rocks and other objects from hampering or becoming wedged in scooter wheels.

### BACKGROUND ART

Wheeled scooters have recently become popular with children and adults, both for recreation and personal transportation. Conventional scooters generally have a board with a front wheel and a rear wheel connected to the bottom of the board and a handle extending upwards from the front of the board with which to steer the scooter. To operate a conventional scooter, the user places one foot on the board, grasps the handle, and propels the scooter forward by pushing off with the other foot.

U.S. Pat. No. D439,623 to Barrera discloses such a scooter. Barrera discloses a scooter with a board coupled to two wheels and a steering column with a handle. The Barrera scooter is also capable of being folded.

There are many variations on the conventional scooter. A common variation is to make the scooter collapsible and thus more portable and easier to store when not in use. U.S. Pat. No. D433,718 to McGreen discloses a portable collapsible scooter and U.S. Pat. No. 6,158,751 to Wu et. al. discloses a skating board folding structure. The McGreen patent discloses an ornamental design for a typical scooter with a footboard structure coupled to two wheels and a steering column with a handle and braking mechanism. The scooter disclosed in the Wu patent may be collapsed and thus made more portable by folding the steering column down against the footboard structure. The scooter of the Wu patent generally comprises a handle stem and a handle connected to a head tube, a front wheel connected to the base of the head tube, a support connected to the board extending at a certain inclination from the peripheral of the head tube, a rear wheel connected to the rear of the board, and a folding knuckle provided between the head tube and the board. The handle stem pivots at the folding knuckle to fold up against the board.

Another variation on the conventional scooter is to make it convertible into other forms. U.S. Pat. No. 6,089,586 to Rudell et al. discloses a children's ride-on toy that can be transformed between a tricycle and a scooter. A convertible skateboard/scooter is disclosed in U.S. Pat. No. 6,199,880 to Favorito et al.

Rudell discloses a children's ride-on toy, convertible between a tricycle and a scooter configuration. The toy has a rigid frame member that may be moved between a first tricycle position and a second scooter position. The same handlebars are used in both configurations.

Favorito discloses a convertible skateboard/scooter that comprises a base board with wheels coupled to a lower side of the base board and a handle. The handle is hinged to the base board and is movable between a first position in which the device can be used as a conventional skateboard, and a second position in which the device can be used as a conventional scooter.

With the recent increased popularity of scooters comes an increase in scooter-related injuries. A number of scooter designs have been offered with improvements to scooter safety in mind.

U.S. Pat. No. 6,206,388 to Ouboter discloses a scooter board with a simplified control system structure. A conventional scooter board generally has a board with two front wheels and a rear wheel connected to the bottom thereof and a handle extending from the front end so as to control the turning movement. The handle has to be adjustable so that users of varying heights may properly hold the handle and control the scooter. Ouboter discloses a scooter board that is suitable for various persons to use as the control bar needs only one hand to hold it, simplifying the control system.

Many scooter-related injuries, however, occur when one or both of the scooter's wheels encounter rocks or other debris on the riding surface, which can cause the scooter to suddenly stop, propelling the rider forward and off of the scooter. Because of this danger, the range of riding surfaces upon which conventional scooters can be used is preferably limited to those that are smooth and free from rocks and other debris.

There have been some attempts to rectify this problem. U.S. Pat. No. 4,145,065 to Kupka discloses a roller skate scooter. The scooter generally comprises an articulated support platform with pivotally connected forward and rearward footboards. At least one wheel is secured to the underside of each footboard and a steering assembly, such as a semi-cylindrical cab, is mounted upon the front footboard for remotely and arcuately maneuvering the first footboard generally in a horizontal plane about a pivot point. The cab has a semi-cylindrical front surface for substantially protecting the rider and for avoiding puncturing other objects and persons during accidental collision. The cab defines a shield that is constructed and arranged to substantially deflect the flow of oncoming air generally around the body of the rider during propulsion of the scooter.

While the cab of the scooter disclosed by Kupka may work to protect the rider, neither it nor any of the known prior art addresses the problem of debris on the riding surface hampering or becoming wedged in scooter wheels.

### SUMMARY OF THE INVENTION

The problems outlined above are addressed and in large measure overcome by the present invention. The present invention improves the safety of wheeled scooters and makes them more versatile by increasing the range of riding surfaces upon which scooters may safely be used. The present invention improves upon the prior art by inhibiting the wheels of a scooter from being hampered by rocks and other debris that may be on the riding surface. While the scooter is in motion, the present invention deflects objects away from the wheels by pushing the objects off to the sides and out of the path of the wheels. This prevents any debris from becoming wedged in the wheels and suddenly stopping the scooter. The present invention is also inexpensively manufactured and may be mounted permanently or temporarily onto any existing scooter or incorporated into the design and manufacture of new scooters.

The present invention comprises a debris-engaging element and a mounting element adapted to operably attach the debris-engaging element to a scooter. The mounting element is attached to the scooter such that the debris-engaging element is positioned in front of the scooter's front wheel. Thus, when the scooter is in motion, any rocks or debris that come into the path of the scooter's wheels first contact the debris-engaging element and are pushed off to the sides and out of the path of the wheels.

### BRIEF DESCRIPTION OF THE DRAWINGS

FIG. 1 is a perspective view of the present invention mounted to a scooter;

FIG. 2 is an enlarged perspective view of the present invention mounted to a scooter;

FIG. 3 is an enlarged side view of the present invention mounted to a scooter; and

FIG. 4 is an enlarged top view of the present invention mounted to a scooter.

### DETAILED DESCRIPTION OF THE PREFERRED EMBODIMENTS

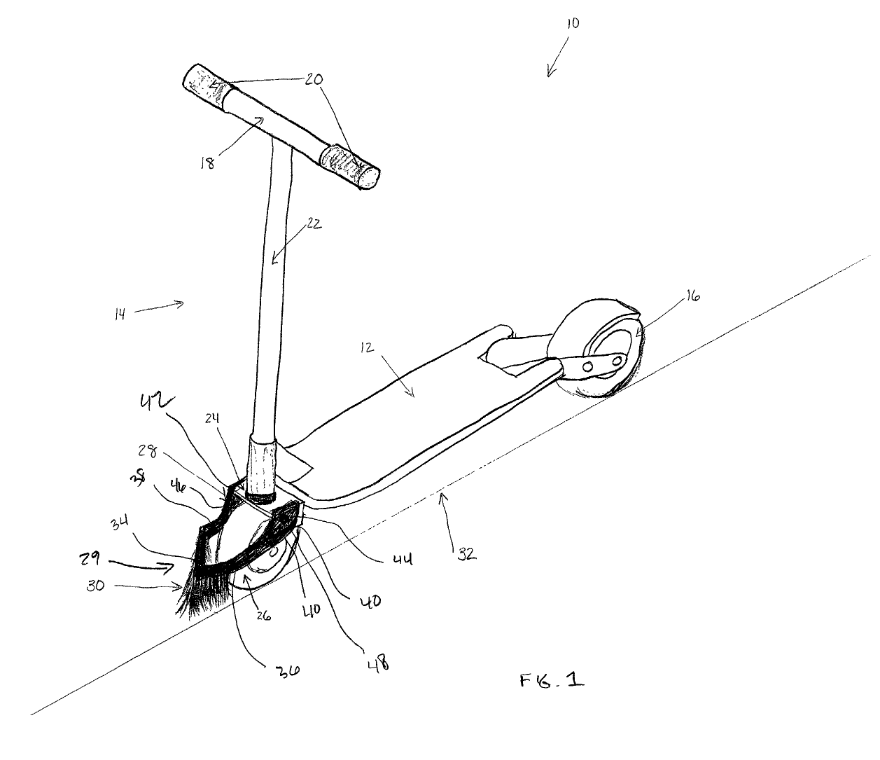

Referring to the drawings, a scooter 10 in accordance with the present invention generally includes a footplate 12, a steering assembly 14 and a rear wheel 16, as illustrated in FIG. 1. The steering assembly 14 generally comprises a handlebar 18 with two hand grips 20, a support column 22, a front wheel fork 24 and a front wheel 26. The rear wheel 16 and front wheel 26 engage a riding surface 32 when the scooter 10 is in use.

An apparatus 29 for inhibiting stones and other objects from engaging the wheels 26, 16 of the scooter 10 includes debris-engaging element 30, and a mounting element 28. The mounting element 28 is pivotally attached to the front wheel fork 24 of the scooter 10 in such a way so as to position the debris-engaging element 30 in front of the front wheel 26 and near or on the riding surface 32. The mounting element 28 may be permanently or removably attached to the front wheel fork 24.

In one embodiment, the debris-engaging element 30 is semi-rigid, and can preferably be a brush, and the mounting element 28 is a rigid metal bracket.

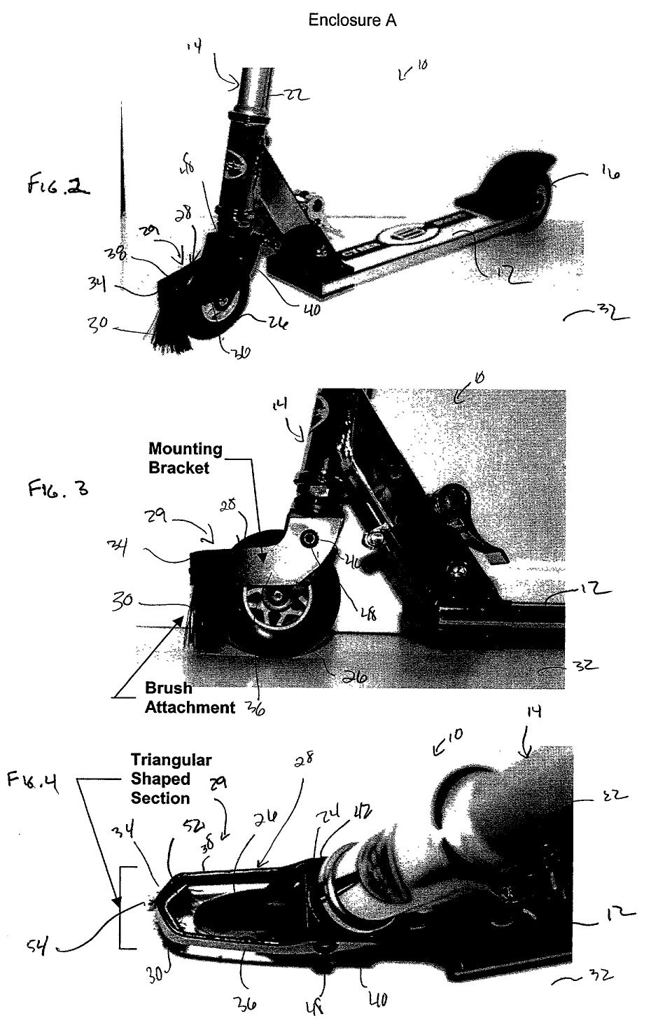

Referring in particular to FIGS. 2 and 3, the mounting element 28 is designed to pivot between a lowered surface-clearing position and a raised position at a mounting point 34. In a raised position, the debris-engaging element 30 and mounting element 28 remain coupled to the scooter 10 but leave the front wheel 26 exposed. This can be desired, for instance, when the scooter 10 is used to perform tricks or other maneuvers that require the front wheel 26 to be exposed. Enabling the mounting element 28 to pivot between raised and lowered positions improves the versatility of the scooter 10 and frees a user from having to repeatedly remove and reattach the mounting element 28.

More particularly, the mounting element 28 can be a metal bracket having a generally curved or V-shaped surface 34 and rearwardly extending arms 36, 38. Each arm 36, 38 includes a rearwardmost upwardly extending connection portion 40, 42, respectively. Apertures 44, 46 in each of the upwardly extending connection portions 40, 42 receive a mounting pivot pin 48.

The debris engaging element 30, most typically a brush, is carried on the front curved or V-shaped surface 34. Referring in particular to FIG. 4, it will be seen that a brush mounting plate 52 is carried in place on the inside of the bracket front surface 34 by mounting screw 54. The mounting plate tightly wedges the brush 30 in place on the mounting element 28, and can be conveniently removed by loosening mounting screw 54 for adjustment or replacement of the brush. Although not depicted in the drawings, the top of the mounting element can be enclosed with a cover, thereby blocking water spray from contacting the rider of the scooter.

In operation, a user grasps the hand grips 20, places a foot on the footplate 12 and pushes off the riding surface 32 with the other foot, propelling the scooter 10 forward. As rocks or other debris appear on the riding surface 32 in the path of the scooter 10, they contact the debris-engaging element 30 preceding the front wheel 26 as the scooter 10 is in motion. The debris-engaging element 30 prevents the debris from interfering with the front wheel 26 and forward motion of the scooter 10 by propelling the debris to the sides and out of the path of both the front wheel 26 and rear wheel 16.

What is claimed is:

1. A pathway clearing apparatus for clearing stones and other debris from the pathway of a scooter having a footplate, front and rear ground engaging wheels operably coupled to the footplate, and a steering assembly operably coupled to the front wheel of the scooter, said clearing apparatus comprising a mounting bracket, and a debris engaging element carried by said mounting bracket, said mounting bracket adapted for operable attachment to said scooter for orienting said debris engaging element in front of said scooter front wheel whereby debris is pushed aside from said scooter pathway and inhibited from coming into contact with said scooter front wheel when said scooter is operated along said pathway.

2. The invention of claim 1, said mounting bracket being operably, pivotally attached to said scooter and shiftable between a lowered, debris engaging position, and a raised position.

3. The invention of claim 1, said debris engaging element comprising a brush.

4. The invention of claim 3, said mounting bracket including a front surface and two rearwardly extending arms, said brush being removably held in place on said front surface by a mounting bracket.
